(19) United States
(12) Patent Application Publication
(10) Pub. No.: US 2024/0144389 A1
(43) Pub. Date: May 2, 2024

(54) Communication Analysis and Correlation Method to Identify and Track Digital Personas Through Wireless Communications

(71) Applicant: Geoffrey E Korrub, Austin, TX (US)

(72) Inventor: Geoffrey E Korrub, Austin, TX (US)

(21) Appl. No.: 17/976,855

(22) Filed: Oct. 30, 2022

(51) Int. Cl. G06Q 50/00

(52) U.S. Cl. CPC G06Q 50/01

(57) ABSTRACT

A method for identifying a digital persona includes collecting metadata developed at least in part from passively collecting device metadata transmissions from one or more simultaneously observed devices, comparing collected metadata to values, whether known or machine learning developed, creating a device profile for the one or more simultaneously observed devices from the compared metadata, observing time-based information for the one or more observed device profiles, and creating digital persona therefrom.

### BACKGROUND OF THE INVENTION

### Field of the Invention

The present invention relates generally to wireless communication data analysis, and more particularly to communication analysis and correlation method to identify and track digital personas through wireless communications

### BRIEF SUMMARY OF THE INVENTION

In today's ever connected world, nearly every manufactured product contains communications capabilities utilizing one or more common industry standards such as Wi-Fi, Bluetooth, Lora, LTE, and 5G to name just a few. These devices are ever present on people, and within homes and businesses. Passively identifying the presence of these devices through the observation of their communications without the need to interact directly with the devices provides visibility into what can be described as components of a digital persona. The digital persona of a person, place, or thing is a combination of the observations of protocol metadata utilized to build device observations. Observed device combinations are further used to build an understanding of personas while time bounded data sets may be further utilized to understand authorized presence.

The building of a digital persona begins with the passive collection of protocol metadata that is communicated in an observable band. This passively collected data may be augmented by actively collected data that involves either communicating with the device under observation or an upstream device to request information about a device under observation.

### BRIEF DESCRIPTION OF THE FIGURES

The novel features believed to be characteristic of the invention are set forth in the appended claims and claims yet to be filed. However, the invention itself, as well as preferred modes of use and further objectives and advantages thereof, will best be understood by reference to the following detailed description when read in conjunction with the accompanying Figures wherein:

FIG. 1 shows an example of wireless handshake and solution placement;

FIG. 2 shown a protocol fingerprinting example; and

FIG. 3 shows digital persona building from metadata observations.

### DETAILED DESCRIPTION OF THE PREFERRED EMBODIMENTS

Detailed descriptions of the preferred embodiments are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

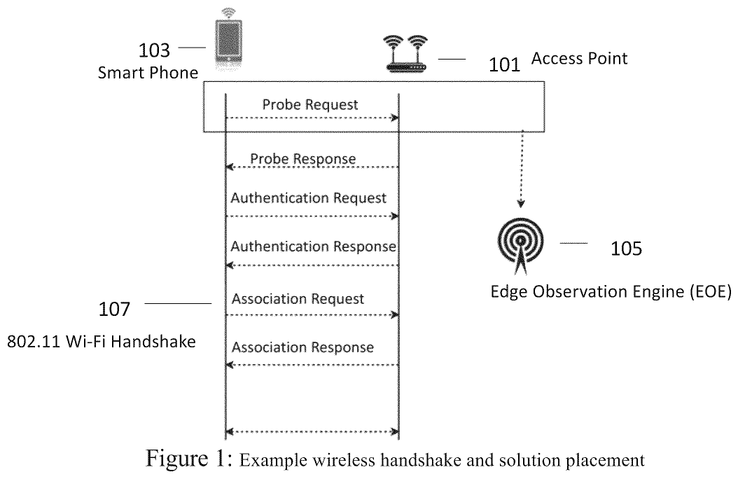

Telecommunication technologies of most types engage in handshake procedures to build and maintain a compatible communications one-to-one pathway. Examples of this would be but are not limited to the Laptop-to-Access Point relationship in 802.11 Wi-Fi, the Headphones-to-Medial player in Bluetooth, and the Smart Phone to Cell Tower in 5G, see 107, FIG. 1.

In each of these handshakes, the devices involved begin the handshake with a request that contains a series of values, and informational elements that are designed to provide both as compatibility check and as an optimization mechanism for the communication channel being set up.

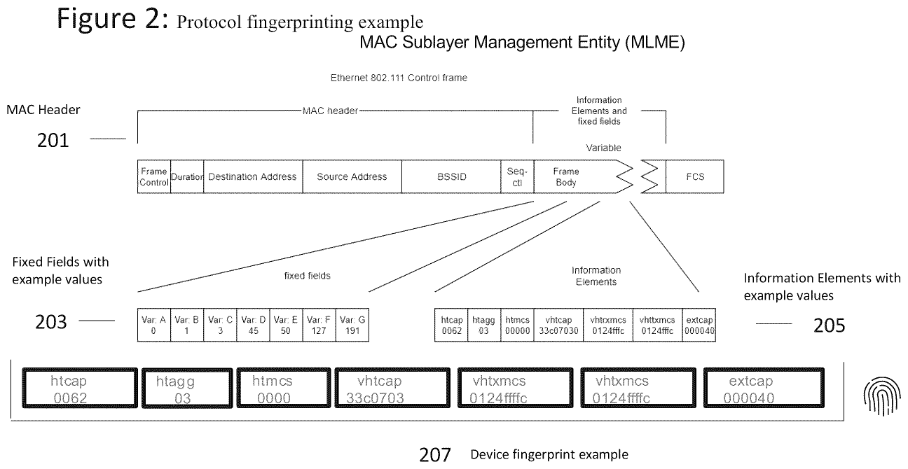

An example source of these communications properties is discovered within the MLME frame control portion of a network control frame used to communicate between a wireless client and a wireless access point. With attention to FIG. 2, MLME, for Medium Access Control (MAC) Sublayer Management Entity, is associated with wireless communications. The MLME protocol contains fields such as htcap and htagg. This is a capabilities bitmask for the HT capabilities information element, 205. Other elements currently include, htagg, htmcs, vhtcap, vhtrxmcs, and extcap, however the protocol is vendor expandable and an ever-increasing number of these variables 207 will be available in the future and are to be considered in this example.

These communications may be any number of protocols including Wired Ethernet, Wi-Fi, Zigbee, Bluetooth (BT), Bluetooth low energy (BLE), LoRA, GSM, GPRS, LTE, 5G or any other transmission technology that sets operating parameters for its transmission.

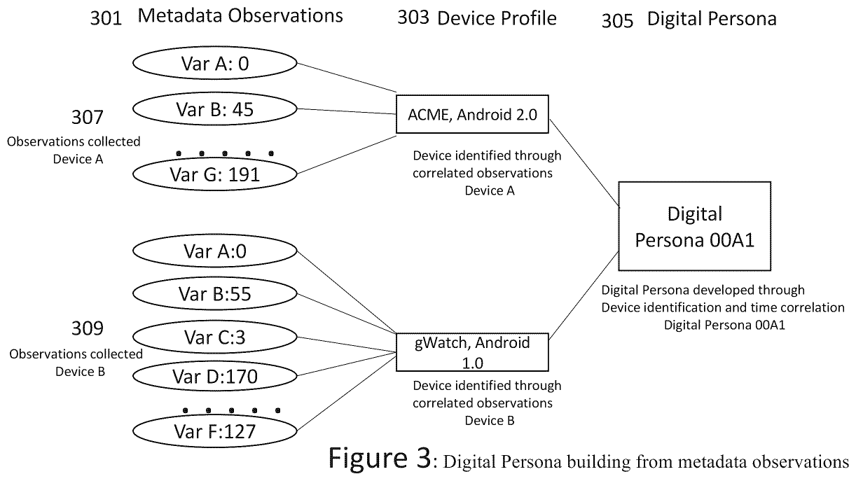

The combination of these protocol fields as well as the set values can be utilized to understand what device is communicating by developing a fingerprint based on the observations, FIG. 3.

At this point in the observation process, the fingerprint may only be semi-unique, and require enrichment. To achieve this enrichment passively, over time observation including simultaneously observed devices also identified through the same fingerprint process are connected to build a Digital Persona (DP) 305.

These DPs developed from observation and correlation may have additional enrichment applied in the form of patterns of presence that the system may observe and alert from.

One or more Edge Observation Engine(s) (EOE) 105 are deployed in physical areas as required to observe and collect communications for metadata collection, abstraction and analysis. The EOE devices may have one or more antenna across one of more communications protocols to enable the passive collection of any communications required to build a digital persona and optionally develop time bounded behavior sets.

Each EOE device way locally summarize the observed communications through a combination of traffic filtering and local processing. The EOEs may transfer their observations over a communications path for processing.

Each EOE device will locally summarize the observed communications through a combination of traffic filtering and local processing. The EOEs may transfer their observations over a communications path for processing.

As this embodiment many be inclusive of multiple EOEs across a geographic area the transferring of these observations will enable a broader correlation against the other EOEs in the system.

In one embodiment one of more EOEs are deployed as a software solution 103 on multi-propose hardware such as an app on a smart phone. This software-based deployment model may be software only, or may be deployed alongside additional non-software based EOEs.

In these deployments the software-based solution, if mobile, may utilize the GPS systems available on the platform to communicate the location that observations were made from. Each EOE device may locally summarize the observed communications through a combination of traffic filtering and local processing. The EOEs may transfer their observations over a communications path for processing.

In an additional embodiment observed network traffic may be captured and utilized for correlation. This embodiment utilizes the EOE devices as in the previous embodiments but captures additional information either through an additionally proposed EOE(s), dedicated EOE(s), a software or hardware collector, or through a direct system integration.

Examples of observable data that are envisioned to be beneficial to the correlation process include but are not limited to protocol level metadata such as RTS, CTS, DNS, ARP, and DHCP variables, and ICMP implementation details, or any other additionally identifying protocol data. Supplemental heuristics such as hostname, DNS-SD, or other identifying network data may also be incorporated into the fingerprinting process.

In yet an additional embodiment, the system may be implemented as previously described, but with the EOE devices transmitting non-summarized or pre-enriched data back over the communications path for upstream correlation (FIG. 1).

While the invention has been described in connection with preferred embodiments, it is not intended to limit the scope of the invention to the particular forms set forth, but on the contrary, it is intended to cover such alternatives, modifications, and equivalents as may be included within the spirit and scope of the invention as defined by the appended claims, and claims that may issue.

What is claimed:

1. A method for identifying a Digital Persona comprising the following steps:
Collecting metadata developed at least in part from passively collecting device metadata transmissions from one or more simultaneously observed devices;
Comparing collected metadata to know observed values (or machine learned;
Creating a device profile for the one or more simultaneously observed devices from the compared metadata;
Observing time-based information for the one or more observed device profiles; and
Creating digital persona therefrom.

2. The method as claimed in claim 1 wherein the observed transmission(s) has/have no pre-determined size.

3. The method in claim 1 further comprising collecting any number of transmissions on any number of frequencies simultaneously or over time and are limited only by the hardware's capabilities on which this method is implemented.

4. The method as claimed in claim 1 wherein further compromising extracting from the data frame metadata properties-based frame format, both common properties such as speed offering and service capabilities as well as proprietary, unique identifying information such as an embedded hash or Certificate key.

5. The method as claimed in claim 1 where in further device definition may be obtained through enrichment by a central or distributed correlation action utilizing learned observations from additional collectors.

6. The method as claimed in claim 1 wherein the collections are stored and accessible either pre or post correlation either internally by the system for use and or externally as a product of the system.

7. The method as claimed in claim 1 wherein further device definition may be obtained through enrichment by a central or distributed correlation action utilizing learned observations from active sources such as users' directories integrations, and network and server logs.
